(19) United States
(12) Patent Application Publication
(10) Pub. No.: US 2018/0093463 A1
(43) Pub. Date: Apr. 5, 2018

(54) COMPOSITE MATERIAL AND METHOD OF MANUFACTURING VEHICLE INTERIOR MATERIAL USING THE SAME

(71) Applicant: Seoyon E-Hwa Co., Ltd., Seoul (KR)

(72) Inventors: Dong Won KIM, Chungcheongnam-do (KR); Ki Sung KIM, Chungcheongnam-do (KR)

(21) Appl. No.: 15/718,160

(22) Filed: Sep. 28, 2017

(30) Foreign Application Priority Data
Sep. 30, 2016 (KR) 1020160126131

(51) Int. Cl. B32B 27/32; B32B 37/06; B32B 37/10

(52) U.S. Cl. CPC B32B 27/32; B32B 37/06; B32B 37/10; B60R 13/02; B32B 2255/02; B32B 2605/003; B32B 2307/718

(57) ABSTRACT

Disclosed herein are a composite material and a method of manufacturing a vehicle interior material using the same. The composite material is manufactured by laminating first and second substrates which each include a felt layer consisting of a natural fiber and a synthetic fiber, a polyolefin film layer, and a thermosetting resin coating layer. Through such a structure, it is possible to implement high stiffness and a reduction in weight, to prevent crushing, occurrence of irregularity, breaking, etc. due to expression of an impregnated resin from front and back surfaces of a conventional material, and to easily attach a bracket and a surface material in a post-treatment process.

### CROSS-REFERENCE TO RELATED APPLICATIONS

This application claims priority to Korean Patent Application No. 10-2016-0126131, filed on Sep. 30, 2016, the disclosure of which is incorporated herein by reference in its entirety.

### BACKGROUND OF THE INVENTION

### Field of the Invention

Exemplary embodiments of the present invention relate to a composite material and a method of manufacturing a vehicle interior material using the same, and more particularly, to a composite material, which is capable of implementing high stiffness and a reduction in weight and improving product formability, and a method of manufacturing a vehicle interior material using the same.

### Description of the Related Art

A natural fiber composite material is produced by mixing a polymeric material with a natural fiber or a biomass, instead of filler such as a glass fiber, a carbon fiber, or talc. The natural fiber composite material is also called an eco-friendly composite material, a biocomposite material, an eco-composite material, green plastic, or the like.

As a representative example of natural fiber composite materials, there are a natural fiber-reinforced board produced by needle punching a natural fiber and a chemical fiber as disclosed in Korean Patent Application Publication No. 10-2003-0093823, a composite material produced by laminating a natural fiber sheet and a polyolefin foam, a natural fiber/thermosetting binder produced by impregnating a natural fiber with a thermosetting resin, and the like. They are used to manufacture rear shelves, trunk trims, headliners, door trims, etc.

Among them, the most widely applied natural fiber-reinforced board is to be developed for replacement of resin felt. The natural fiber-reinforced board is formed as a vehicle interior component in such a way to produce a felt layer by needle punching a natural fiber and a chemical fiber and then to form a plate by hot compression and cold compression molding. However, the natural fiber-reinforced board is problematic in that it causes poor formability, such as bursting and tearing, due to a lack of elongation when forming an edge portion or a severe bent portion.

In addition, the natural fiber/thermosetting binder is a high-stiffness material that is developed to implement a reduction in weight, instead of composite PP which is a material for a vehicle interior door trim. The natural fiber/thermosetting binder is produced in such a way to spray and impregnate upper/lower surfaces of a natural fiber felt layer with a thermosetting resin and then to process it by hot compression molding. The natural fiber/thermosetting binder can implement a reduction in weight at a high level by virtue of using the thermosetting resin having high stiffness, but it is problematic in that a back bracket is adhered using adhesive such as hot melt after manufacturing of a core. Moreover, since the natural fiber/thermosetting binder uses a spray-type thermosetting binder, it may lead to a deterioration in surface quality due to expression of a binder resin from the front and back surfaces of the binder.

### SUMMARY OF THE INVENTION

An object of the present invention is to provide a composite material, which is capable of implementing high stiffness and a reduction in weight and of preventing crushing, occurrence of irregularity, breaking, etc. due to expression of an impregnated resin from front and back surfaces of a conventional material, and a method of manufacturing a vehicle interior material using the same.

Another object of the present invention is to provide a composite material, which enables easy attachment of a bracket and a surface material in a post-treatment process, and a method of manufacturing a vehicle interior material using the same.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with one aspect of the present invention, a composite material includes a first substrate produced by attaching a polyolefin film to one surface of a first felt layer consisting of a natural fiber and a synthetic fiber to form a first polyolefin film layer, and by coating the first polyolefin film layer with a thermosetting resin to form a first thermosetting resin coating layer, and a second substrate produced by attaching a polyolefin film to one surface of a second felt layer consisting of a natural fiber and a synthetic fiber to form a second polyolefin film layer, and by coating the other surface of the second felt layer or the second polyolefin film layer with a thermosetting resin to form a second thermosetting resin coating layer, the second substrate being laminated to the first substrate.

The first and second substrates may be laminated such that the second thermosetting resin coating layer is disposed on the other surface of the first felt layer.

The second substrate may be configured such that the second thermosetting resin coating layer is formed on the other surface of the second felt layer.

Alternatively, the second substrate may be configured such that the second thermosetting resin coating layer is formed on the second polyolefin film layer.

The natural fiber may be one or more selected from a group consisting of jute, kenaf, sisal, flax, and bamboo.

The synthetic fiber may be one or more selected from a group consisting of polypropylene, polyester, low-melting polyester, and nylon.

The first and second felt layers may each be formed such that the natural fiber and the synthetic fiber have a weight ratio of 9:1 to 6:4.

The first and second polyolefin film layers may each be formed to have an amount of 50 to 200 g/m².

The thermosetting resin may be one or more selected from a group consisting of urethane, epoxy, acryl, phenol, amino resin, and a mixture thereof.

The thermosetting resin may further include an additive, and the additive may be one or more selected from a group consisting of glass fiber, mineral fiber, talc, calcium carbonate, and carbon fiber.

The first thermosetting resin coating layer may have 5 to 100 wt % based on the weight of the first felt layer.

The second thermosetting resin coating layer may have 5 to 100 wt % based on the weight of the second felt layer.

In accordance with another aspect of the present invention, a method of manufacturing a vehicle interior material using a composite material includes producing a first substrate by attaching a polyolefin film to one surface of a first felt layer consisting of a natural fiber and a synthetic fiber to form a first polyolefin film layer, and by coating the first polyolefin film layer with a thermosetting resin to form a first thermosetting resin coating layer, producing a second substrate by attaching a polyolefin film to one surface of a second felt layer consisting of a natural fiber and a synthetic fiber to form a second polyolefin film layer, and by coating the other surface of the second felt layer or the second polyolefin film layer with a thermosetting resin to form a second thermosetting resin coating layer, manufacturing a composite material by laminating the first substrate and the second substrate, preheating and temporarily forming the composite material by compression at a temperature of 100 to 250° C. for 10 to 60 seconds, and completely forming the composite material by cold compression in a mold for cold molding, after the preheating and temporarily forming the composite material.

In the manufacturing a composite material, the composite material may be manufactured by disposing the second thermosetting resin coating layer on the other surface of the first felt layer and by then laminating the first substrate and the second substrate.

The second substrate may be configured such that the second thermosetting resin coating layer is formed on the other surface of the second felt layer.

Alternatively, the second substrate may be configured such that the second thermosetting resin coating layer is formed on the second polyolefin film layer.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically illustrating a composite material according to an embodiment of the present invention;

FIG. 2 is a view schematically illustrating a composite material according to another embodiment of the present invention;

FIG. 3 is a flow chart schematically illustrating a method of manufacturing a composite material and a method of manufacturing a vehicle interior material using the same according to the embodiments of the present invention; and

FIG. 4 is a diagram schematically illustrating the method of manufacturing the composite material and the method of manufacturing a vehicle interior material using the same according to the embodiments of the present invention.

### DESCRIPTION OF SPECIFIC EMBODIMENTS

In order to help understanding of features of the present invention, a composite material and a method of manufacturing a vehicle interior material using the same according to exemplary embodiments of the present invention will be described below in more detail.

Throughout the disclosure, like reference numerals refer to like parts throughout the various figures and embodiments of the present invention. In certain embodiments, detailed descriptions of constructions or functions well known in the art may be omitted to avoid obscuring appreciation of the disclosure by a person of ordinary skill in the art.

Hereinafter, exemplary embodiments of the present invention will be described in more detail with reference to the accompanying drawings.

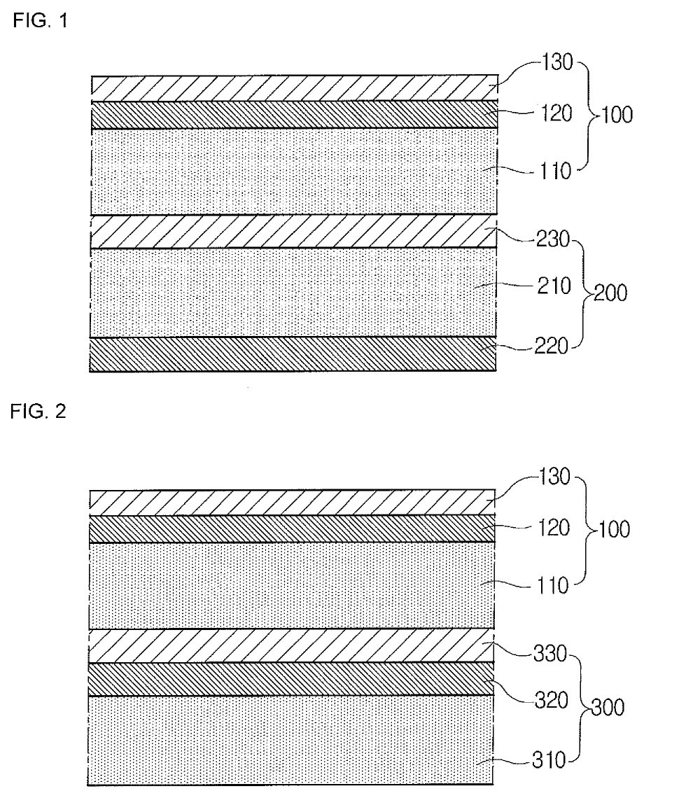

FIGS. 1 and 2 are views schematically illustrating a composite material according to an embodiment and another embodiment of the present invention. The composite material is configured by laminating substrates, each of which includes a felt layer consisting of a natural fiber and a synthetic fiber, a polyolefin film layer formed by attaching a polyolefin film thereto, and a thermosetting resin coating layer formed by applying and coating a thermosetting resin thereon.

In more detail, the composite material according to the embodiment of the present invention is manufactured by laminating a first substrate 100 and a second substrate 200, as illustrated in FIG. 1.

Here, the first substrate 100 includes a first felt layer 110 that consists of a natural fiber and a synthetic fiber, a first polyolefin film layer 120 that is formed by attaching a polyolefin film to one surface of the first felt layer 110, and a first thermosetting resin coating layer 130 that is formed by coating the first polyolefin film layer 120 with a thermosetting resin.

The second substrate 200 includes a second felt layer 210 that consists of a natural fiber and a synthetic fiber, a second polyolefin film layer 220 that is formed by attaching a polyolefin film to one surface of the second felt layer 210, and a second thermosetting resin coating layer 230 that is formed by coating the other surface of the second felt layer 210 with a thermosetting resin.

The composite material is manufactured by disposing and laminating the second thermosetting resin coating layer 230 on the other surface of the first felt layer 110. That is, the composite material is manufactured by disposing and laminating the second thermosetting resin coating layer 230 of the second substrate 200 on the first felt layer 110 of the first substrate 100.

In addition, the composite material according to another embodiment of the present invention is manufactured by laminating a third substrate 300 on the first substrate 100, as illustrated in FIG. 2.

Here, the third substrate 300 includes a third felt layer 310 that consists of a natural fiber and a synthetic fiber, a third polyolefin film layer 320 that is formed by attaching a polyolefin film to one surface of the third felt layer 310, and a third thermosetting resin coating layer 330 that is formed by coating the third polyolefin film layer 320 with a thermosetting resin.

The composite material is manufactured by disposing and laminating the third thermosetting resin coating layer 330 on the other surface of the first felt layer 110. That is, the composite material is manufactured by disposing and laminating the third thermosetting resin coating layer 330 of the third substrate 300 on the first felt layer 110 of the first substrate 100.

Through such a structure, the composite material can improve stiffness and prevent crushing, occurrence of irregularity, breaking, etc. due to expression of an impregnated resin from the front and back surfaces of a conventional material. In addition, it is possible to easily attach a bracket and a surface material in a post-treatment process.

Hereinafter, the felt layers 110, 210, and 310, the polyolefin film layers 120, 220, and 320, and the thermosetting resin coating layers 310, 320, and 330 will be in more detail. Here, the felt layers, the polyolefin film layers, and the thermosetting resin coating layers used to manufacture the first, second, and third substrates 100, 200, and 300 are identical.

Each of the felt layers 110, 210, and 310 includes a natural fiber and a synthetic fiber. The natural fiber includes one or more selected from the group consisting of jute, kenaf, sisal, flax, and bamboo, and the synthetic fiber includes one or more selected from the group consisting of polypropylene, polyester, low-melting polyester, and nylon. Of course, the present invention is not limited thereto.

The felt layer (110, 210, or 310) is formed such that the natural fiber and the synthetic fiber have a weight ratio of 9:1 to 6:4. Here, if the amount of the synthetic fiber included in the felt layer is less than 10%, a loss rate may increase due to a lack of cohesive force between fibers in the process of carding felts, resulting in a deterioration in physical properties. On the other hand, if the amount of the synthetic fiber exceeds 40%, the content of the natural fiber serving as filler is reduced, resulting in a deterioration in physical properties and an increase in cost.

Each of the polyolefin film layers 120, 220, and 320 may be formed by attaching a polyolefin film to one surface of the associated felt layer 110, 210, or 310. The inclusion of the polyolefin film layer allows for improving odors and stiffness. Especially, the polyolefin film layer enables the bracket to be easily attached by back injection molding in the post-treatment process, without an adhesion process such as a hot melt process. The polyolefin film layer 120, 220, or 320 may be formed on one surface of the associated felt layer 110, 210, or 310 at an amount of 50 to 200 g/m². Here, if the amount of the polyolefin film layer is less than 50 g/m², the adhesive layer has an insufficient thickness and hence the bracket may not be stably attached. On the other hand, if the amount of the polyolefin film layer exceeds 200 g/m², the weight and cost of the substrate are increased due to excessive use of material in the state in which the adhesive force of the bracket is not increased above a certain level.

In addition, the presence of the polyolefin film layers 120, 220, and 320 allows for attaching the surface material using latent heat after the end of product formation. That is, the inclusion of the polyolefin film layers 120, 220, and 320 allows for easily performing the attachment of the surface material.

Each of the thermosetting resin coating layers 130, 230, and 330 may be formed by a thermosetting resin sprayed through resin injection nozzles, and may have 5 to 100 wt % based on the weight of the associated felt layer. If the weight of the thermosetting resin coating layer is less than 5% based on the weight of the felt layer, the improvement of stiffness is insignificant even after hardening the thermosetting resin coating layer. On the other hand, if the weight of the thermosetting resin coating layer exceeds 100%, the weight of the substrate is excessively increased, and therefore it is inconsistent with the purpose of the present invention for implementing a reduction in weight.

Here, the thermosetting resin includes one or more selected from the group consisting of urethane, epoxy, acryl, phenol, amino resin, and a mixture thereof, but the present invention is not limited thereto.

In addition, an inorganic filler may be added to the thermosetting resin composite for reinforcement of stiffness. The inorganic filler representatively includes one or more selected from the group consisting of glass fiber, mineral fiber, talc, calcium carbonate, and carbon fiber, but the present invention is not limited thereto.

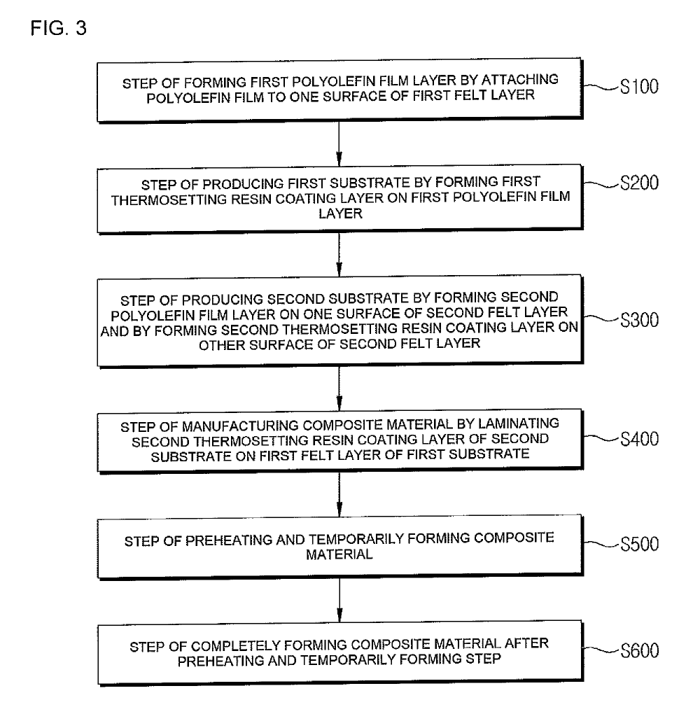

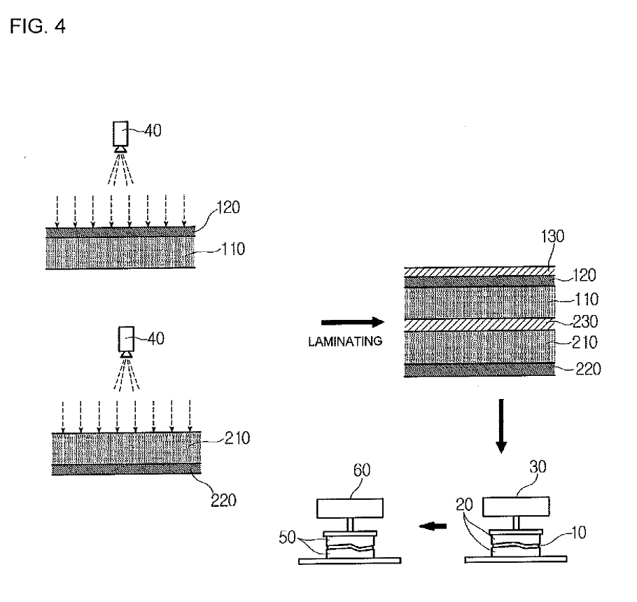

FIGS. 3 and 4 are a flow chart and a diagram schematically illustrating a method of manufacturing a composite material and a method of manufacturing a vehicle interior material using the same according to the embodiments of the present invention.

Referring to FIGS. 3 and 4, the method of manufacturing a vehicle interior material using a composite material according to the embodiment of the present invention includes a step of forming a first polyolefin film layer by attaching a polyolefin film to one surface of a first felt layer (S100), a step of producing a first substrate by forming a first thermosetting resin coating layer on the first polyolefin film layer (S200), a step of producing a second substrate by forming a second polyolefin film layer on one surface of a second felt layer and by forming a second thermosetting resin coating layer on the other surface of the second felt layer (S300), a step of manufacturing a composite material by laminating the second thermosetting resin coating layer of the second substrate on the first felt layer of the first substrate (S400), a step of preheating and temporarily forming the manufactured composite material (S500), and a step of completely forming the composite material (S600) after the step of preheating and temporarily forming the composite material (S500).

When the composite material is manufactured by laminating the first and second substrates in the step of manufacturing a composite material (S400), the second thermosetting resin coating layer is laminated on the lower portion of the first felt layer of the first substrate.

The step of preheating and temporarily forming the composite material (S500) serves to harden the thermosetting resin to form the composite material. Thus, it is possible to prevent separation of a deep-draw portion caused when a press plate is heated and compressed, and then processed by cold molding, and to prevent bursting of an edge portion caused by hardening of a thermosetting resin in the related art. In the step of preheating and temporarily forming the composite material (S500), hot compression is performed on the composite material in a state in which the composite material is heated using a mold for temporary molding similar to the final shape of a product.

Here, if the conventional method of heating and compressing a plate is used in the step of preheating and temporarily forming the composite material (S500), the thermosetting resin coating layer, which is between the surface of the first substrate and the adhesive surface of the first and second substrates, is hardened by heat, resulting in hardening of the thermosetting resin. Hence, the thermosetting resin coating layer may be separated from the felt layer or be broken in bent and deep-draw portions after final cold compression.

However, when the composite material is heated and compressed using a mold for temporary molding 20 as in the embodiment of the present invention, it is possible to prevent separation and breaking of the thermosetting resin coating layer in bent and deep-draw portions even though the thermosetting resin coating layer is linearly hardened by heat.

The mold for temporary molding 20 has a bent shape of about 30 to 100% with respect to the R (radius of curvature) value of the bent portion of the final product. If the R value of the bent portion of the mold for temporary molding 20 is less than 30%, the thermosetting resin coating layer may be still separated and broken due to an insignificant amount of temporary molding in the subsequent complete forming step. On the other hand, if the R value of the bent portion of the mold for temporary molding 20 exceeds 100%, the thermosetting resin coating layer may be already separated and broken due to an excessive amount of temporary molding in the step of preheating and temporarily forming the composite material (S500). For this reason, the division of the forming step into two steps is meaningless.

In addition, in the step of preheating and temporarily forming the composite material (S500), it is preferable to form the substrate by compressing the composite material at a temperature of 100 to 250° C. for 10 to 60 seconds in consideration of the melting points of the natural fiber and the synthetic fiber. Of course, this forming condition is properly adjustable according to the characteristics of material forming the substrate 10.

In the complete forming step (S600) after the step of preheating and temporarily forming the composite material (S500), it is possible to produce a finished product by extracting the temporarily formed substrate 10 from the mold for hot compression, and transferring the extracted substrate to a mold for cold molding 50 to process it by cold compression.

The complete forming step (S600) is a step of forming the composite material by cold molding. In step S600, it is possible to produce a product by cooling the product for 10 to 60 seconds after the completion of compression for sufficiently hardening the product. In addition, it is possible to attach brackets to the cold-formed product by insert injection molding, vibration welding, or hot melt welding.

The composite material according to the embodiment of the present invention may further include a non-woven fabric that is laminated as a surface material on the outer surface thereof and is made of a polyolefin or polyester material. This non-woven fabric layer forms the surface of the product and can implement various textures and colors and mechanical and chemical properties.

The present invention will now be described in more detail with reference to examples. It will be apparent by those skilled in the art that these examples are provided so that the present invention will be thorough and complete and should not be construed as being limited to the examples set forth herein.

### EXAMPLES

[Manufacturing of Vehicle Interior Material using Composite Material]

Each of first, second, and third substrates is produced by forming a felt layer consisting of a natural fiber and a synthetic fiber at a ratio of 50:50, the natural fiber being provided as kenaf, the synthetic fiber being provided as polyester and polypropylene, by attaching a polyolefin film (foam film) having a weight of 100 g/m² to one surface of the felt layer to form a polyolefin film layer, and by spraying 5 to 100 wt % of urethane (thermosetting resin), based on the weight of the felt layer, onto the polyolefin film layer or the other surface of the felt layer to form a thermosetting resin coating layer.

Here, the first and second substrates are laminated and heated and compressed at a temperature of 150° C. for 60 seconds using a mold for temporary molding. The substrates, which are sufficiently preheated and temporarily formed, are finally hardened by cold compression in a mold for complete molding, so as to be formed as a vehicle interior material.

In more detail, the composite material is configured as in the following Table 1.

TABLE 1

| | | Composite |
|---|---|---|
| | | Material |
| | Composition | Structure |
| Example 1 | 50 g/m² of thermosetting resin | See FIG. 1 |
| | (5 wt % based on the weight of felt layer) | |
| Example 2 | 200 g/m² of thermosetting resin | See FIG. 1 |
| | (20 wt % based on the weight of felt layer) | |
| Example 3 | 300 g/m² of thermosetting resin | See FIG. 1 |
| | (30 wt % based on the weight of felt layer) | |
| Example 4 | 1000 g/m² of thermosetting resin | See FIG. 1 |
| | (100 wt % based on the weight of felt layer) | |
| Example 5 | 200 g/m² of thermosetting resin | See FIG. 2 |
| | (20 wt % based on the weight of felt layer) | |
| Example 6 | 300 g/m² of thermosetting resin | See FIG. 2 |
| | (30 wt % based on the weight of felt layer) | |
| Comparative | 900 g/m² of polypropylene (PP) fiber | |
| Example 1 | (100 wt % based on the weight of felt layer) | |
| Comparative | 10 g/m² of thermosetting resin | See FIG. 1 |
| Example 2 | (1 wt % based on the weight of felt layer) | |
| Comparative | 1500 g/m² of thermosetting resin | See FIG. 1 |
| Example 3 | (150 wt % based on the weight of felt layer) | |

In Examples 1 to 4 and Comparative Examples 2 and 3, a second substrate 200 laminated on a first substrate is produced by forming a second polyolefin film layer 200 on one surface of a second felt layer 210 and spraying a thermosetting resin onto the other surface of the second felt layer 210 to form a second thermosetting resin coating layer 230, as illustrated in FIG. 1.

In Examples 5 and 6, a third substrate 300 laminated on a first substrate 100 is produced by spraying a thermosetting resin onto the upper surface of a third polyolefin film layer 320 to form a third thermosetting resin coating layer 330, as illustrated in FIG. 2, with the consequence that the third substrate 300 has the same structure as the first substrate 100.

### Test Examples

[Measurement of Flexural Strength, Weight, Weight Reduction Rate, & Back Adhesive Force of Vehicle Interior Material using Composite Material]

In order to check the stiffness and the reduction in weight of the product manufactured according to the present embodiments, a flexural strength, a weight, a weight reduction rate, and a back adhesive force are measured.

The flexural strength is measured according to the method provided by ISO 178, and the size and speed of a test piece are 50 mm×150 mm and 5 mm/min, respectively.

The weight is actually measured by collecting five or more of test pieces having a size of 100 mm×100 mm from the different sections of the manufactured product, and the weight reduction rate is calculated by comparison with those mass-produced in Comparative Example 1.

The back adhesive force is measured as a force when a bracket is tensioned and detached at a speed of 50 mm/min using a universal test machine (UTM).

TABLE 2

| | | | | | | | Comp. | Comp. | Comp. |
|---|---|---|---|---|---|---|---|---|---|
| | Ex. 1 | Ex. 2 | Ex. 3 | Ex. 4 | Ex. 5 | Ex. 6 | Ex. 1 | Ex. 2 | Ex. 3 |
| Weight | 1050 | 1200 | 1300 | 2000 | 1200 | 1300 | 1800 | 1010 | 2500 |
| (g/m²) | | | | | | | | | |
| Flexural | 345 | 365 | 415 | 550 | 372 | 420 | 355 | 320 | 640 |
| Strength | | | | | | | | | |
| (kgf/cm²) | | | | | | | | | |
| Weight | 42 | 33 | 28 | — | 33 | 28 | — | 43 | −38 |
| Reduction | | | | | | | | | |
| Rate (%) | | | | | | | | | |
| Back | 26 | 32 | 32 | 33 | 26 | 25 | 25 | 26 | 34 |
| Adhesive | | | | | | | | | |
| Force (kgf) | | | | | | | | | |

As a result of testing a vehicle interior material in Comparative Example 1 to 3 and Examples 1 to 6, the vehicle interior material manufactured according to the present invention has improved stiffness as a thermosetting resin content is increased, compared to that mass-produced in Comparative Example 1, as indicated in Table 2. In addition, there is a difference in adhesive force between brackets at the back surface of the interior material depending on the laminated structure thereof.

On the other hand, when the thermosetting resin coating layer is formed by 1 wt % based on the weight of the felt layer as in Comparative Example 2, the product has a high weight reduction rate, but it has low flexural strength. In addition, when the thermosetting resin coating layer is formed by 150 wt % based on the weight of the felt layer as in Comparative Example 3, the product has a high back adhesive force and high flexural strength, but it is heavy. Hence, the product in Comparative Examples 2 and 3 is unsuitable in view of the tendency of lightweight vehicle interior materials.

The composite material used as the vehicle interior material may be manufactured by selecting one of the structures in FIGS. 1 and 2 according to the purpose thereof.

As is apparent from the above description, in accordance with a composite material and a method of manufacturing a vehicle interior material using the same, it is possible to implement high stiffness and a reduction in weight and to prevent crushing, occurrence of irregularity, breaking, etc. due to expression of an impregnated resin from front and back surfaces of a conventional material. In addition, it is possible to easily attach a bracket and a surface material in a post-treatment process.

While the present invention has been described with respect to the specific embodiments, it will be apparent to those skilled in the art that various changes and modifications may be made without departing from the spirit and scope of the invention as defined in the following claims.

What is claimed is:

1. A composite material comprising:
a first substrate produced by attaching a polyolefin film to one surface of a first felt layer consisting of a natural fiber and a synthetic fiber to form a first polyolefin film layer, and by coating the first polyolefin film layer with a thermosetting resin to form a first thermosetting resin coating layer; and
a second substrate produced by attaching a polyolefin film to one surface of a second felt layer consisting of a natural fiber and a synthetic fiber to form a second polyolefin film layer, and by coating the other surface of the second felt layer or the second polyolefin film layer with a thermosetting resin to form a second thermosetting resin coating layer, the second substrate being laminated to the first substrate.

2. The composite material according to claim 1, wherein the first and second substrates are laminated such that the second thermosetting resin coating layer is disposed on the other surface of the first felt layer.

3. The composite material according to claim 1, wherein the natural fiber is one or more selected from a group consisting of jute, kenaf, sisal, flax, and bamboo.

4. The composite material according to claim 1, wherein the synthetic fiber is one or more selected from a group consisting of polypropylene, polyester, low-melting polyester, and nylon.

5. The composite material according to claim 1, wherein the first and second felt layers are each formed such that the natural fiber and the synthetic fiber have a weight ratio of 9:1 to 6:4.

6. The composite material according to claim 1, wherein the first and second polyolefin film layers are each formed to have an amount of 50 to 200 g/m².

7. The composite material according to claim 1, wherein the thermosetting resin is one or more selected from a group consisting of urethane, epoxy, acryl, phenol, amino resin, and a mixture thereof.

8. The composite material according to claim 7, wherein:
the thermosetting resin further comprises an additive; and
the additive is one or more selected from a group consisting of glass fiber, mineral fiber, talc, calcium carbonate, and carbon fiber.

9. The composite material according to claim 1, wherein the first thermosetting resin coating layer has 5 to 100 wt % based on the weight of the first felt layer.

10. The composite material according to claim 1, wherein the second thermosetting resin coating layer has 5 to 100 wt % based on the weight of the second felt layer.

11. A method of manufacturing a vehicle interior material using a composite material, comprising:
producing a first substrate by attaching a polyolefin film to one surface of a first felt layer consisting of a natural fiber and a synthetic fiber to form a first polyolefin film layer, and by coating the first polyolefin film layer with a thermosetting resin to form a first thermosetting resin coating layer;
producing a second substrate by attaching a polyolefin film to one surface of a second felt layer consisting of a natural fiber and a synthetic fiber to form a second polyolefin film layer, and by coating the other surface of the second felt layer or the second polyolefin film layer with a thermosetting resin to form a second thermosetting resin coating layer;
manufacturing a composite material by laminating the first substrate and the second substrate;
preheating and temporarily forming the composite material by compression at a temperature of 100 to 250° C. for 10 to 60 seconds; and
completely forming the composite material by cold compression in a mold for cold molding, after the preheating and temporarily forming the composite material.

12. The method according to claim 11, wherein in the manufacturing a composite material, the composite material is manufactured by disposing the second thermosetting resin coating layer on the other surface of the first felt layer and by then laminating the first substrate and the second substrate.
